(19) United States
(12) Patent Application Publication
(10) Pub. No.: US 2023/0332365 A1
(43) Pub. Date: Oct. 19, 2023

(54) Imbalance Exciter for Soil Compaction Devices

(71) Applicant: Wacker Neuson Produktion GmbH & Co. KG, Reichertshofen (DE)

(72) Inventor: Michael Steffen, Munich (DE)

(21) Appl. No.: 18/133,696

(22) Filed: Apr. 12, 2023

(30) Foreign Application Priority Data
Apr. 14, 2022 (DE) 10 2022 109 299.2

(51) Int. Cl. E02D 3/074; E01C 19/35; E01C 19/38

(52) U.S. Cl. CPC E02D 3/074; E01C 19/35; E01C 19/38

(57) ABSTRACT

An unbalance exciter for a soil compaction device comprises at least two rotatable unbalance masses which are rotatably mounted in opposite directions relative to each other, and at least two rotors. Each of the unbalance masses is coupled to a respective one of the rotors. The at least two unbalance masses and the associated rotors are mounted coaxially relative to each other. A stator is associated with each of the rotors in such a way that each rotor and the associated stator form an electric motor.

### BACKGROUND OF THE INVENTION

### 1. Field of the Invention

The invention relates to an unbalance exciter for a soil compaction device and to a soil compaction device equipped with such an unbalance exciter.

### 2. Discussion of the Related Art

Vibration plates or vibratory plates are known for their use as soil compaction devices, which plates generally have an upper mass and a bottom mass which is movable in an oscillating manner relative to the upper mass. A drive motor, usually an internal combustion engine, is frequently provided at the upper mass, which drives an unbalance exciter via a mechanical coupling (for example, a belt drive) or a hydraulic coupling, which is arranged at the bottom mass. The unbalance exciter generates vibrations that, for soil compaction, may be directly introduced into a soil contact plate belonging to the bottom mass.

Instead of an internal combustion engine, it is also known to use an electric motor, which may be arranged on the upper mass or also directly on the bottom mass.

The unbalance exciter suitable for soil compaction devices may have one or more unbalance shafts which are rotatable and on which an unbalance mass is selectively mounted. When the unbalance shaft rotates, the rotating unbalance mass generates vibration forces due to centrifugal force, which forces may be used for soil compaction.

In the case of smaller vibratory plates, so-called drag vibrators, only one unbalance shaft with a rotating unbalance mass is generally used. Larger vibratory plates, some of which are steerable, frequently have two unbalance shafts arranged parallel to each other and coupled to rotate, for example, by means of a gearbox, in opposite directions. It is possible for the centrifugal forces that occur during rotation to partially cancel each other out by means of the unbalance shafts that may be driven in opposite directions and at the same speed. In particular, the phase position of the unbalance shafts or alternatively of the unbalance masses provided thereon may be adjusted with the aid of a phase adjustment device in such a way that the vertical components of the centrifugal forces generated by the unbalance masses add up, whereas the horizontal components of the centrifugal forces at least partially cancel each other out. This may be used, for example, to generate an on-the-spot compaction, which is to say, a localized compaction of the soil.

By changing the phase position, horizontal force components may also be generated specifically to achieve a forward or backward movement of the vibratory plate. In the case of appropriate design of the unbalance exciter, it is possible to achieve rotatability or steerability of the vibratory plate. This is, in particular, enabled by dividing one of the unbalance shafts into two coaxial unbalance shafts rotating in the same direction, which are arranged to rotate together in opposite directions to a third unbalance shaft.

Examples of such vibration exciters are known from DE 30 43 719 C2 and DE 29 09 204 A1. The effect of the vertical and horizontal components is also elucidated in DE 199 43 391 A1.

In vibratory plates with an electric unbalance drive, power may be transmitted from an electric power source to the electric motor by means of cables or wirelessly via inductive components. Power sources may be batteries carried on board or external power sources (rechargeable batteries, public power grid, other machines with adequate preparation).

Unbalance drives with electric motors integrated into or coupled to the unbalance exciter require installation space to perform their assigned functions. When compared to an unbalance exciter driven by an internal combustion engine, for example, by means of a belt drive or a hydraulic drive, for the same performance, an unbalance drive with an electric motor requires considerably more installation space on the bottom mass, if the electric motor is also to be arranged on the bottom mass. In addition, the combination of unbalance drive and electric motor on the bottom mass has a less favorable power-to-weight ratio compared to a belt pulley (as part of a belt drive) or to a hydraulic motor (as part of a hydraulic drive).

With an increase in the demands relating to the functionality and tasks of the electric motor-driven vibratory plates (forward travel, reverse travel, turning, steering), the mass and volume of the electric motors used increase, which means that the overall installation volume, weight and cost also increase, whereas convenience deteriorates. In particular in the case of larger vibratory plates, this makes the use of electric motors much more difficult.

A very compact electric motor-driven unbalance exciter for a soil compaction device is known from DE 10 2020 100 842 A1, in which the rotor of an electric motor simultaneously comprises an unbalance mass, wherein the rotor is only partially enclosed around the circumference by a stator.

### SUMMARY

The invention is based on the task of minimizing the constructional complexity of an unbalance exciter for a soil compaction device in such a way that all tasks for which a plurality of motors or complete couplings of a plurality of exciters to a drive motor are required in known systems may be performed with a minimum of technical components. In this way, in addition to a reduction in costs and weight, it is also possible to save on installation space.

According to the invention, the task is solved by an unbalance exciter comprising at least two rotatable unbalance masses which are rotatably mounted in opposite directions relative to each other, and at least two rotors. Each one of the unbalance masses is coupled to a respective one of the rotors. The at least two unbalance masses and the associated rotors are mounted coaxially relative to each other. A stator is associated with each of the rotors, in such a way that the rotor and the associated stator form an electric motor.

In this manner, each of the unbalance masses is coupled to its own rotor and is borne by the rotor. The respective rotor together with the unbalance mass in this sense forms an unbalance shaft.

The unbalance mass may be constructed separately from the rotor and then be coupled to it. It is, however, likewise also possible that the unbalance mass is integrated directly into the rotor, such as described, for example, in DE 10 2020 100 842 A1.

In the unbalance exciter according to an aspect of the invention, there are thus at least two unbalance masses that are separate from one another and are driven by two electric motors that are likewise also separate from one another, each of which with a rotor and a stator. The rotational axles of the unbalance masses and thereby of the rotors are arranged coaxially to each other, which is to say, on a common axis.

Different motor types may be realized as electric motors, for example, external rotor motors, internal rotor motors, induction motors, synchronous motors, synchronous reluctance motors, switched reluctance motors, brushless DC motors, electronically commutated motors, stepper motors or similar. The rotors and stators are respectively to be designed in a corresponding manner.

An unbalance mass may also comprise a plurality of (partial) unbalance mass elements or alternatively be formed by them, which, however, interact with regard to the rotor bearing them and thus together result in the (common) unbalance mass. Accordingly, the rotor bears the unbalance mass or alternatively the plurality of unbalance mass elements forming it.

The rotors and the unbalance masses they respectively bear are mounted coaxially to each other on a common virtual rotational axle.

In so doing, a plurality of designs are possible: the rotors with the unbalance masses may thus also be mounted to rotate in opposite directions on a common physical rotational axle. Likewise, the rotors may also be mounted on separate physical rotational axles, which must then however be arranged coaxially to each other, in particular on a common virtual rotational axle.

A control system may be provided for the control of the electric motors and thus for adjusting and changing the phase position of the at least two unbalance masses relative to each other. The importance of adjusting the phase position has already been elucidated above in connection with the prior art. In this context, reference should again be made to DE 199 43 391 A1 and DE 29 09 204 A1, in which the basic principle for the adjustment of the phase position is presented, such that it is unnecessary to repeat it here.

The control system is capable of precisely adjusting the phase position of each rotor and thus of the associated unbalance mass, in particular by controlling the respective electric motor. Through the interaction of the centrifugal forces, a resulting force vector is formed by the unbalance exciter, which unbalance exciter acts in the desired manner on the soil contact plate bearing the unbalance exciter and thus on the soil to be compacted.

In one variant, at least one of the stators may surround only a circular segment of the circumference of the rotor assigned to it. This means that the stator does not completely surround the rotor, but rather only partially surrounds it. Accordingly, the circular segment is in particular lesser than 360°.

Alternatively, it is also possible for the stator to be substantially cylindrical and to completely surround the rotor at the circumference in a cylindrical or sleeve-like manner.

The unbalance mass coupled to a rotor may have, for example, two unbalance mass elements, each of which may be attached laterally to the end faces of the substantially disk-shaped rotor. The unbalance mass elements may accordingly be borne by the rotor, with the rotational axle of the unbalance mass elements and the rotational axle of the rotor coinciding.

The unbalance mass elements may in turn also consist of, for example, several sheet metal elements or alternatively be of sheet metal construction, wherein the sheet metal elements are fastened laterally to the rotor.

A physical axle may be provided, wherein the unbalance masses are mounted together with the associated rotors on the axle so as to be rotatable in opposite directions. In this variant, a common physical axle is thus provided for the unbalance masses and the rotors. In this case, the physical axle coincides with the virtual rotational axle mentioned above. The physical axle may be rigidly mounted, for example, in a suitable housing or support, and the rotors borne by the axle may each be mounted on the axle with suitable bearings, for example, roller bearings.

In one variant, each of the unbalance masses with its associated rotor may be mounted on its own (physical) axle element. This makes it possible to respectively build a unit with a rotor, an unbalance mass and its own axle element.

Each of the rotors may be coupled to an axle element which is rotatably mounted in a mounting device. In this variant, the rotor is not rotatably mounted on the axle element, but rather is coupled to the axle element, in particular rigidly coupled in the direction of rotation, for example, by a suitable shaft-hub connection. The axle element in turn is then rotatably mounted in a mounting device, whereby the associated rotor is also rotatably mounted with the unbalance mass.

In a particular embodiment, it is possible that the mounting device, the axle element, the stator, the rotor and the unbalance mass coupled to the rotor may form an exciter unit. The exciter unit may, in particular, be a compact unit that may be installed individually. An exciter unit thereby comprises precisely one rotor and one axle element. The stator may completely or partially (solely about a circular segment) enclose the rotor at the circumference.

The single exciter unit may be combined with one further exciter unit or with a plurality of further exciter units. In this case, the one exciter unit is an assembly that is individually manageable. The exciter unit may be mounted as a whole unit and be fastened, for example, to the soil contact plate of a vibratory plate.

The unbalance exciter according to an aspect of the invention may advantageously be used with a soil compaction device. Accordingly, a soil compaction device is provided with an upper mass, with a bottom mass movable relative to the upper mass, with a soil contact plate for soil compaction, with a vibration decoupling device acting between the upper mass and the bottom mass, and with an unbalance exciter associated with the bottom mass of the type described above for applying an unbalance force to the soil contact plate.

The soil compaction device, for example, a vibration or vibratory plate, may thereby be constructed in a very cost-effective and space-saving manner, because the unbalance exciter relevant for its performance may be constructed very compactly at the bottom mass according to the specifications given above.

In one embodiment, the unbalance exciter may have at least two exciter units mounted on the soil contact plate, wherein the exciter units are arranged relative to one another on the soil contact plate in such a way that the rotors of the two exciter units are arranged coaxially relative to one another on a common virtual rotational axle and may be rotated in opposite directions relative to one another. Accordingly, the two exciter units, respectively forming a compact unit as described above, are arranged one behind the other as viewed in the axial direction, wherein the rotors are rotatable in opposite directions.

The control system may be configured to adjust in a desired manner the phase position of the rotors and thereby the unbalance masses in the exciter units. The adjustment of the phase position may, for example, occur by appropriate control of the excitation of the electric motors or control of the stator poles. In addition, an operating device may be provided for an operator to specify a control request for the action of the soil compaction device. The operating device may be, for example, a remote control or remote operation, which has control elements, such as a joystick, with which the operator may specify their control request.

The operating device may be coupled to the control system in order to implement the wish of the operator which is specified by the operator by actuating the operating device. For this purpose, the control system may accordingly adjust the phase position of the rotors rotating in the opposite direction. For this purpose, it is useful if the control system respectively knows the exact position of the rotor or alternatively of the unbalance mass provided on the rotor and thereby “knows” exactly which centrifugal force vector is generated by the rotor and by the unbalance mass. As elucidated above, the phase position of the rotors rotating against each other determines the resulting force effect of the unbalance exciter and thus, on the one hand, the compaction effect and on the other hand the forward or backward movement. In addition, in an unbalance exciter with a plurality of rotors, a rotating effect about the vertical axis or alternatively a steering effect may also be generated if the phase position of the rotors with the unbalance masses is set accordingly.

According to an aspect of the invention, it is thus possible to have designs in which an unbalance exciter has only one rotational axle or alternatively one shaft, which is simultaneously the motor shaft for a plurality of electric (drive) motors and unbalances driven by them. Due to the simple design, different combinations of exciter units may be selected as required. The unbalance masses may be realized by a sheet metal asymmetry on the individual rotors, by selectively creating an unbalance mass by the attachment of sheet metal to a rotor.

The control system allows the motors to be adjusted with respect to their speed and the position angles of the rotors or alternatively the unbalance masses attached to the rotors relative to each other.

It is possible to arrange different types of motors on a common shaft or alternatively rotational axle.

If the stator solely covers a circular segment, which is to say, does not enclose the rotor in a sleeve-like or alternatively cylindrical manner, it is necessary to advance the stator coils onwards in a suitable manner in order to generate a rotation of the rotor. Such motor controls are known (for example, switched reluctance motors).

By sharing a rotational axle or, alternatively, a shaft as well as the shaft bearings in an exciter housing, the number of components otherwise required for known unbalance exciters may be reduced. A plurality of exciter units (electric motors with unbalance masses driven by them) may be combined in one unit. This reduces the installation space requirement and, in particular, the footprint of the unbalance drive. The compactness also increases the robustness of the unbalance exciter. Disturbing tilting moments between the unbalance exciters may be eliminated.

### BRIEF DESCRIPTION OF THE DRAWINGS

These and other advantages and features of the invention are elucidated in more detail below on the basis of examples with reference to the accompanying figures. Wherein:

FIG. 1 shows a schematic top view of an unbalance exciter with two rotors according to the invention;

FIG. 2 shows a variant of FIG. 1;

FIG. 3 shows a schematic top view of an exciter unit which may be used in the unbalance exciter according to the invention;

FIG. 4 shows an example of an exciter unit in perspective view;

FIG. 5 shows the exciter unit of FIG. 4 in side view;

FIG. 6 shows a variant to the unbalance exciters in FIG. 1 and FIG. 2;

FIG. 7 shows a schematic top view of an example of a soil compaction device;

FIG. 8 shows a variant for an unbalance exciter with four rotors;

FIG. 9 shows a variant to the unbalance exciter of FIG. 8;

FIG. 10 to FIG. 12 show further variants to the unbalance exciter of FIG. 8;

FIG. 13 shows an explanation of the centrifugal force effects during operation of the unbalance exciter of FIG. 2;

FIG. 14 shows an explanation of the centrifugal force effects during operation of the unbalance exciter of FIG. 9; and

FIG. 15 shows an explanation of the centrifugal force effects during an operation of the unbalance exciter of FIG. 11.

### DETAILED DESCRIPTION

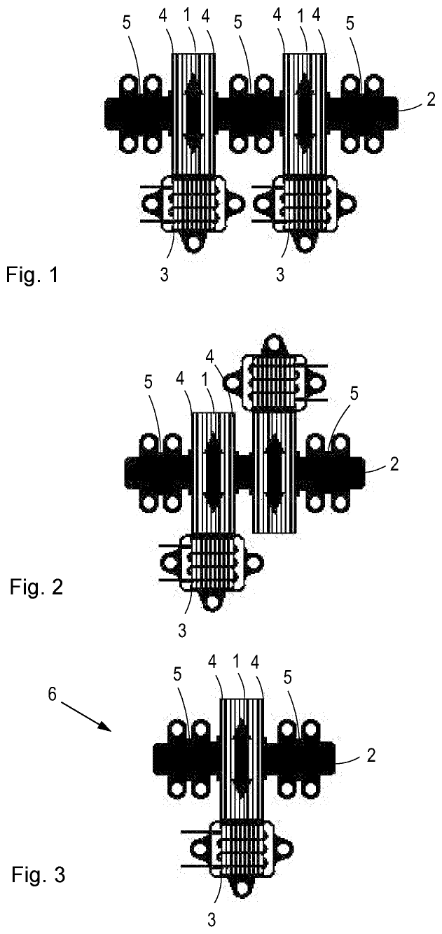

FIG. 1 shows a soil compaction device with two rotors 1, which are mounted to rotate in opposite directions on a common rotational axle 2. The rotational axle 2 may itself be fixed, which is to say, it does not need to be rotatably mounted. The decisive factor is that the rotors 1 are rotatable in opposite directions to each other, which is to say, in opposite directions of rotation.

Rotation of the rotors 1 is brought about by two stators 3 arranged on one side of the rotors 1.

A stator 3 forms an electric motor in conjunction with its associated rotor 1. A control system that is not shown is provided to control each electric motor, which control system is also capable of precisely ascertaining and influencing the respective angular or rotational position of the rotors 1.

In the example shown, the stators 3 do not thereby completely enclose the rotors 1 at the circumference, but rather only partially about a circular segment with a certain angle of lesser than 360°. In so doing, considerable installation space can be saved.

An example of how stators cover only one circular segment on the circumference of a rotors is known from DE 10 2020 100 842 A1.

Unbalance masses 4, which may be formed by a plurality of unbalance mass elements, are respectively attached to the end faces of the rotors 1. The unbalance mass elements may, in particular, be in the form of metal sheets which are fastened to the end faces of the rotors 1, which is to say, laterally, and thus form an unbalance mass 4 for each rotor 1 in its entirety.

“Unbalance mass” in this context means that an eccentric mass is provided on the rotor 1 which eccentric mass provokes a centrifugal force during rotation.

The rotational axle 2 is supported by bearings 5 in a housing that is not shown or on a soil contact plate that is not shown.

Since the control system for the individual electric motors provided for the rotors 1 and stators 3 is designed in such a way that it may influence not only the rotational speed of the rotors 1 but rather also precisely the respective angular position of the rotors 1, and thus the phase position or rotational position of the rotors 1 relative to one another, the centrifugal force vectors generated by the unbalance masses 4 when the two rotors 1 rotate may be precisely set relative to one another.

The rotors 1 are, in particular, rotatable in opposite directions to each other such that—depending on the setting—partial components of the centrifugal force vectors may add up or compensate for each other. This will be explained again later.

The direction of rotation of the rotors 1 is shown by double arrows, wherein during operation different directions of rotation of the two rotors 1 are respectively to be achieved.

FIG. 2 shows a variant to FIG. 1 in which the stators 3 are mounted on different sides in order to save installation space. In addition, the mounting of the rotational axle 2 may be simplified in this variant inasmuch as the middle bearings 5 are omitted in contrast to the design of FIG. 1.

FIG. 3 shows a portion of the unbalance exciter of FIG. 1 and FIG. 2 as a single unit. In this variant, it is possible to divide an unbalance exciter into a plurality of partial exciters 6 or alternatively exciter units. FIG. 3 shows such a partial exciter 6. By way of example, two of the partial exciters 6 shown in FIG. 3 may form an exciter of the type shown in FIG. 1 or FIG. 2, if the two partial exciters 6 of FIG. 3 are combined. Here, too, it is desirable that two rotational axles 2 are then coaxial with each other, which is to say, on a common virtual rotational axle, such that the arrangement of FIG. 1 may be achieved.

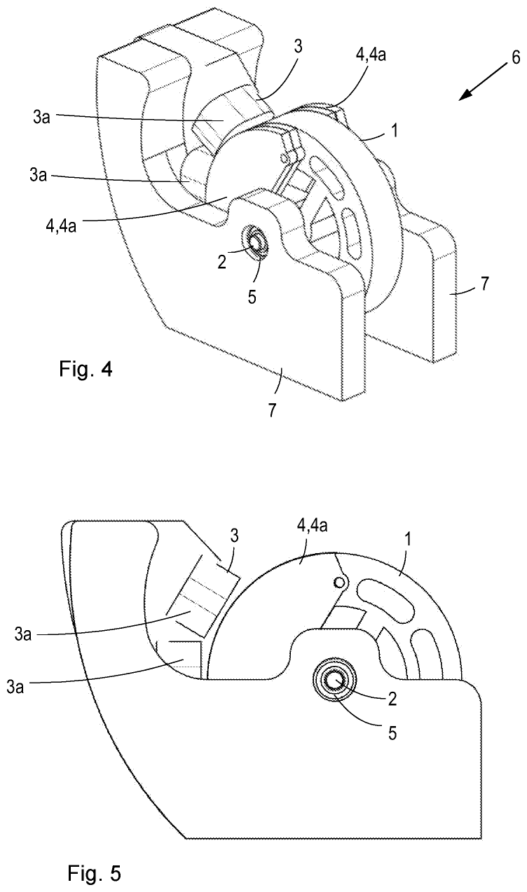

FIG. 4 shows an example of a partial exciter 6 shown only schematically in FIG. 3. FIG. 5 shows the partial exciter in a side view.

The bearings 5 are inserted in two stable side panels 7, which form a mounting device. The bearings 5 rotatably accommodate the rotational axle 2. The rotor 1 is held on the rotational axle 2 and may be coupled to the rotational axle 2, for example, by means of a shaft-hub connection. Likewise, it is also possible that a bearing is provided in the hub of the rotor 1, by means of which the rotor 1 is rotatably mounted on the rotational axle 2. The rotational axle 2 then no longer needs to be rotatably mounted in the side panels 7 but may be held rigidly in the side panels 7.

The unbalance mass elements 4a are fastened to the end faces of the rotor 1 and together form the unbalance mass 4. It is clearly visible in FIG. 4 that the unbalance mass 4 is formed by a plurality of sheet metal elements which are fastened together to the end faces of the rotor 1.

The stator 3 is arranged on the outer circumference of the rotor 1. In so doing, the stator 3 does not extend over the entire circumference of the rotor 1, but rather only over a partial circumference, which is to say, over a circular segment. In the present example, the stator 3 extends over an angle of approximately 90° and has three stator poles 3a, of which only two are visible in FIG. 4 and FIG. 5.

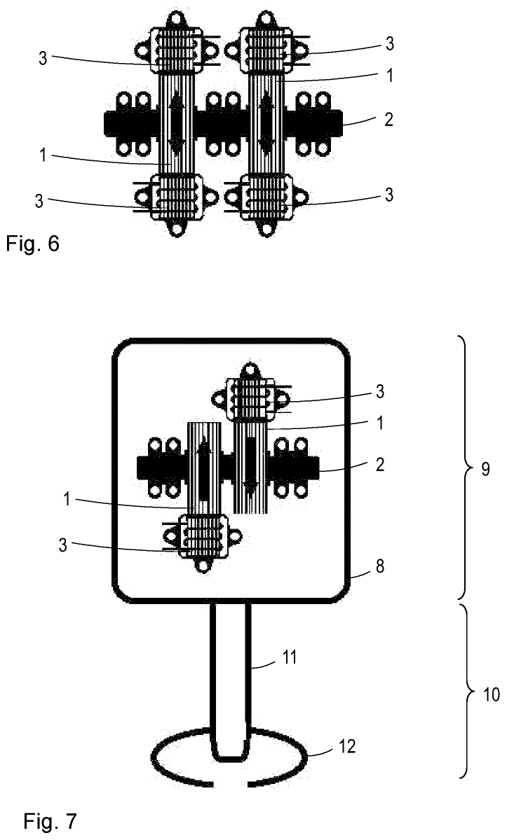

FIG. 6 shows a schematic top view of an arrangement similar to FIG. 1, wherein two stators 3 are however provided for each rotor 1. By providing two stators 3 for each rotor 1, a particularly efficient powerful electric motor may be achieved.

FIG. 7 shows a schematic top view of a vibratory plate serving as a soil compaction device.

The basic construction of such a vibratory plate is known and is shown, for example, in FIG. 1 of DE 10 2020 100 842 A1.

The vibratory plate of FIG. 7 has a soil contact plate 8, upon which the unbalance exciter of FIG. 2 is arranged.

The soil contact plate 8 and the unbalance exciter with the rotors 1, the stators 3, and the rotational axle 2 together form a bottom mass 9.

A partially illustrated upper mass 10 is arranged in the drawing plane seen above the bottom mass 9, which upper mass has a guide drawbar 11 and an operator handle 12. An operator may accordingly steer and guide the entire vibratory plate by grasping the guide handle 12, shown only schematically, via the guide drawbar 11. The upper mass 10 may have further components, for example, a battery as energy storage for the operation of the electric motors as well as corresponding housing or frame components for bearing the battery and for fastening the guide drawbar 11, which however are not shown in FIG. 7.

The upper mass 10 is vibration-decoupled from the bottom mass 9 by means of a corresponding vibration-decoupling device, which is not shown. This device may, for example, be rubber buffers.

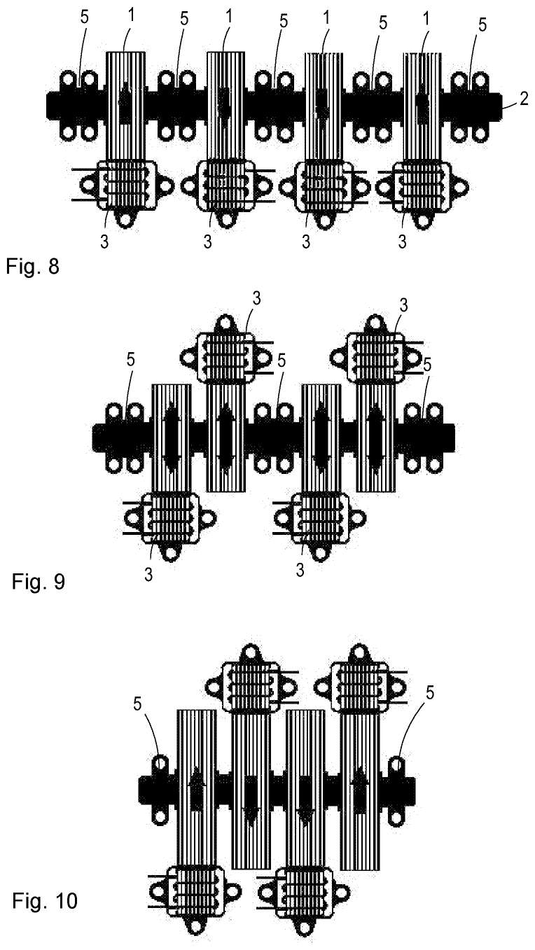

FIG. 8 shows an unbalance exciter with a total of four rotors 1, which are arranged coaxially to each other and are rotatably mounted on a common rotational axle 2. Each of the rotors 1, together with an associated stator 3, forms its own electric motor.

The direction of rotation of the rotors 1 may be set by accordingly controlling the stators 3. In the present example, the two outer rotors 1 rotate upward, whereas the two inner rotors 1 rotate downward (cf. direction of arrow).

FIG. 9 is a variant of FIG. 8, in which two of the stators 3 are arranged opposite each other, similar to the soil compaction device of FIG. 2. In this way, here too a compact construction may also be achieved.

FIG. 10 is another variant in which the rotational axle 2 is mounted only at its outer ends by means of bearings 5, whereas on the inside, between the rotors 1, no bearings are provided, unlike in FIG. 8 and FIG. 9.

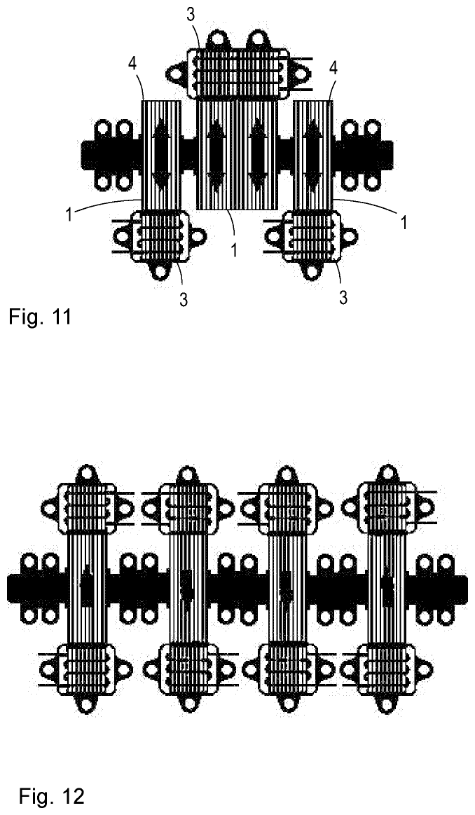

FIG. 11 shows a schematic top view of a further variant in which the two inner rotors 1 are combined to form a common rotor 1, however with double the mass, in particular double the unbalance mass 4. Accordingly, the associated stator 3 is also larger or alternatively extends over a greater width in order to be able to drive the centrally located rotor 1, which weighs twice as much, in rotation. In this, the reference to the mass of the rotor 1 substantially refers to the unbalance mass 4, so that the inner rotor 1 bears an unbalance mass 4 that is twice as large as the unbalance mass 4 of the outer rotor 1.

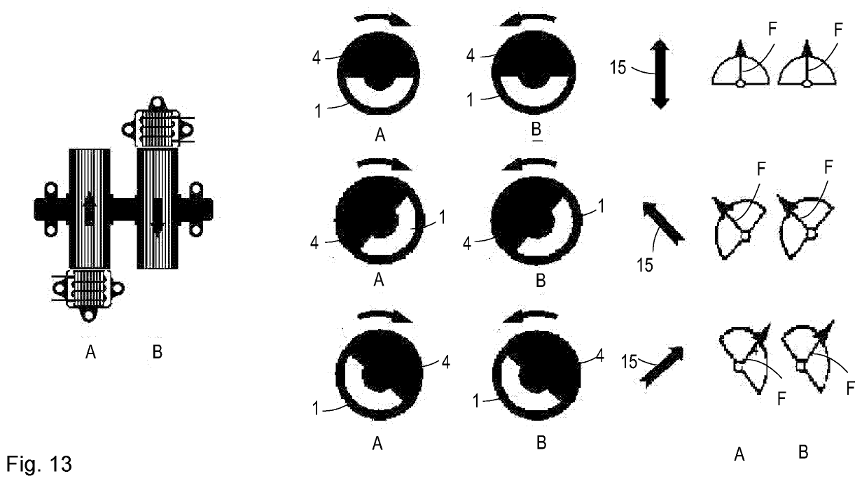

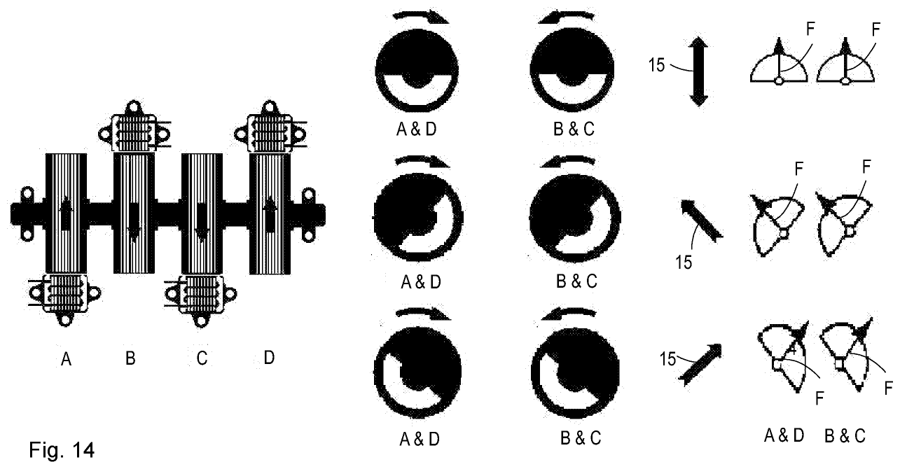

FIG. 12 shows a further variant in which two opposing stators 3 are provided for each rotor 2.

FIG. 13 explains the mode of operation of the unbalance exciter shown by way of example in FIG. 2.

The unbalance exciter comprises two exciter units A and B, with rotors 1, which are mounted on a common rotational axle 2. Unbalance masses 4 in the form of partial unbalance masses are attached to the end faces of the rotors 1.

The middle image section of FIG. 13 shows respective positions of the rotors 1 by way of example, with the unbalance masses 4 borne by them.

Line a) shows a position in which the unbalance masses 4 of the exciter units A and B are respectively at the top at the same time. The centrifugal force vectors F are shown in the right image part of line a). Since the unbalance masses 4 are at the top, the centrifugal force vectors F of the two exciter units A, B are correspondingly also directed upwards.

When the two rotors 1 each perform a 180° rotation, the unbalance masses 4 also rotate 180° in opposite directions. The resulting horizontal components of the centrifugal force vectors F cancel each other out, whereas the vertical components add up, as is shown by a resulting force vector 15 (double arrow to the left of the representation of the centrifugal force vectors F).

In line b) of FIG. 13, the phase position of the two rotors 1 and thereby of the unbalance masses 4 has been changed with the aid of the control system, such that the two unbalance masses 4 that are rotatable in opposite directions are now at an angle of about 45° to the top left. Correspondingly, the centrifugal force vectors F are also directed, as shown in the right image part of line b).

In this case, the horizontal components of the centrifugal force vectors may also at least partially add up, whereby the resulting force vector 15 is tilted obliquely to the left.

In line c), a position of the rotors 1 is shown in which the phase position has been changed in such a way that the unbalance masses 4 are rotated in the representation shown there upwards to the right at an angle of about 45°. Correspondingly, the centrifugal force vectors F are also rotated to the upper right and consequently the resulting force vector 15 is also rotated to the upper right.

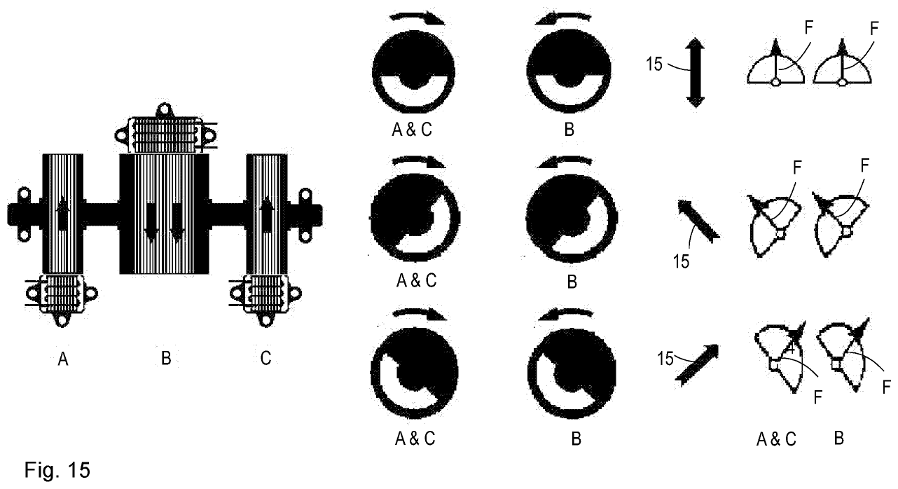

FIG. 14 shows an example of an unbalance exciter with exciter units A, B, C and D, which was elucidated previously on the basis of FIG. 10. Various rotational positions of rotors 1 and unbalance masses 4 are here too shown to illustrate the effects on the centrifugal force vectors F and the thereby resulting force vectors 15.

In line a) of FIG. 14, the respective positions of the rotors 1 and unbalance masses 4 that are rotatable in opposite directions are shown by way of example for the exciter units A and D on the one hand as well as the exciter units B and C on the other hand.

In lines b) and c) of FIG. 14, further positions are shown analogously to FIG. 13.

FIG. 15 shows the unbalance exciter of FIG. 11, with exciter units A, B and C. In lines a) to c), in a manner analogous to FIG. 13 and FIG. 14, corresponding examples are shown for rotational positions of the rotors 1 and unbalance masses 4, rotatable together in the same direction (exciter units A, C) and—with unbalance mass 4 twice as large—rotatable in opposite directions (exciter unit B).

What is claimed is:

1. An unbalance exciter for a soil compaction device, comprising:
at least two rotatable unbalance masses which are mounted rotatably in opposite directions to one another; and
at least two rotors;
wherein
a respective one of the unbalance masses is coupled to each of the rotors;
the at least two unbalance masses and the associated rotors are mounted coaxially to one another; and wherein
a stator is associated with each of the rotors, in such a way that each rotor and the associated stator form an electric motor.

2. The unbalance exciter according to claim 1, further comprising a control system is provided for the control of the electric motors and thus for adjusting and changing the phase position of the at least two unbalance masses relative to each other.

3. The unbalance exciter according to claim 1, wherein at least one of the stators surrounds only a circular segment of a circumference of the rotor assigned to the at least one stator.

4. The unbalance exciter according to claim 1, wherein at least one of the unbalance masses comprises two unbalance mass elements, each of which is laterally mounted on a respective end face of the associated rotor.

5. The unbalance exciter according to claim 1, further comprising an axle, and wherein
the unbalance masses are mounted together with the associated rotors on the axle so as to be rotatable in opposite directions.

6. The unbalance exciter according to claim 1, wherein each of the unbalance masses and its associated rotor is mounted on its own axle element.

7. The unbalance exciter according to claim 1, wherein each of the rotors is coupled to an axle element which is rotatably mounted in a mounting device.

8. The unbalance exciter according to claim 7, wherein the mounting device, the axle element, the stator, the rotor, and the unbalance mass coupled to the rotor form an exciter unit.

9. A soil compaction device, comprising:
an upper mass;
a bottom mass that is movable relative to the upper mass, the bottom mass including a soil contact plate for soil compaction;
a vibration decoupling device acting between the upper mass and the bottom mass; and
an unbalance exciter associated with the bottom mass and being configured to apply an unbalance force to the soil contact plate, the unbalance exciter including.
at least two rotatable unbalance masses which are mounted rotatably in opposite directions to one another; and
at least two rotors;
wherein
a respective one of the unbalance masses is coupled to each of the rotors;
the at least two unbalance masses and the associated rotors are mounted coaxially to one another; and wherein
a stator is associated with each of the rotors, in such a way that each rotor and the associated stator form an electric motor.

10. A soil compaction device according to claim 9, wherein
the unbalance exciter comprises at least two exciter units mounted on the soil contact plate; and wherein
the exciter units are arranged relative to each other on the soil contact plate in such a way that the rotors of the two exciter units are arranged coaxially relative to each other on a common virtual rotational axle and are rotatable in opposite directions relative to each other.

11. The soil compaction device according to claim 9, further comprising a control system that is configured to adjust, in a desired manner, a phase position of the rotors and, thereby, the unbalance masses in the exciter units.

12. The soil compaction device according to claim 9, wherein at least one of the stators surrounds only a circular segment of a circumference of the rotor assigned to the at least one stator.

13. The soil compaction device according to claim 9, wherein at least one of the unbalance masses comprises two unbalance mass elements, each of which is laterally mounted on a respective end face of the associated rotor.

14. The soil compaction device according to claim 9, further comprising an axle, and wherein
the unbalance masses are mounted together with the associated rotors on the axle so as to be rotatable in opposite directions.

15. The soil compaction device according to claim 9, wherein each of the unbalance masses and its associated rotor is mounted on its own axle element.

16. The soil compaction device according to claim 9, wherein each of the rotors is coupled to an axle element which is rotatably mounted in a mounting device.

17. The soil compaction device according to claim 16, wherein the mounting device, the axle element, the stator, the rotor, and the unbalance mass coupled to the rotor form an exciter unit.
